(19) United States
(12) Patent Application Publication
(10) Pub. No.: US 2010/0269141 A1
(43) Pub. Date: Oct. 21, 2010

(54) METHOD FOR PROVIDING A USER WITH A PROGRAM FINDING SERVICE IN A MULTI-CHANNEL BROADCASTING PROGRAM RECEIVER, AND ASSOCIATED MULTI-CHANNEL BROADCASTING PROGRAM RECEIVER

(76) Inventor: Weiqing Yin, Hefei City (CN)

Correspondence Address: NORTH AMERICA INTELLECTUAL PROPERTY CORPORATION, P.O. BOX 506, MERRIFIELD, VA, 22116, US

(21) Appl. No.: 12/488,601

(22) Filed: Jun. 22, 2009

(30) Foreign Application Priority Data
Apr. 21, 2009 (CN) 200910134578.5

(51) Int. Cl. G06F 13/00

(52) U.S. Cl. 725/61

(57) ABSTRACT

A method for providing a user with a program finding service in a multi-channel broadcasting program receiver includes: storing a list comprising a plurality of items, wherein each item represents a program; providing the user with a user interface to allow the user to add, change or adjust an item in the list; and outputting at least a portion of items of the list to be displayed on a screen and allowing the user to select a wanted program from the list, in order to trigger a switching operation for switching to a new channel on which the wanted program is transmitted. An associated multi-channel broadcasting program receiver includes a tuner, a video processing module, a memory and a controller. The tuner is arranged to select a channel. The video processing module is arranged to decode. The controller executing the method provides a user with the program finding service.

### BACKGROUND

The present invention relates to a multi-channel broadcasting program system, and more particularly, to a method for providing a user with a program finding service in a multi-channel broadcasting program receiver, and to an associated multi-channel broadcasting program receiver.

Multi-channel broadcasting program systems such as digital television (TV) receivers have become popular since there are many attractive characteristics such as better image quality and more information for respective programs of different channels. According to the related art, video content and audio content of a program on a channel are typically encoded in order to rapidly transmit the whole program. Thus, a multi-channel broadcasting program system should decode the video content and the audio content of the program to be displayed. For example, the video content and the audio content of the program are MPEG-encoded, and the multi-channel broadcasting program system should MPEG-decode the video content and the audio content of the program to be displayed.

As a result of the decoding load due to the encoding/decoding scheme, there is a delay when a user triggers a channel switching operation. For example, when the user wishes to switch from a first channel to a second channel, there is a delay due to the initial decoding load of a program on the second channel. Afterward, when the user wishes to switch from the second channel to a third channel, there is a delay due to the initial decoding load of a program on the third channel.

As mentioned, delays often occur when switching among channels as long as the encoding/decoding scheme is utilized. Worst of all, when the user navigates from the first channel through to a twenty-first channel, there is a great overall delay due to the initial decoding load of respective programs on these channels.

According to the related art, a favorite channel list may be helpful for decreasing the number of times of channel switching. When the number of times of channel switching is decreased, the overall delay due to the initial decoding load of respective programs on these channels can be decreased. When the favorite channel list is displayed on a screen, however, one may feel uncertain of whether to switch to a channel in the favorite channel list. In contrast to this, looking up program information of respective channels, such as an electronic program guide (EPG) for all channels available, has typically become a required activity for the user. The user may not wish to switch between the EPG and the program contents to make sure which channel to be selected, but is forced to do so, causing great inconvenience.

In addition, unnecessary switching between the EPG and the program contents may increase the total operation time. As a result, it is still hard to further decrease the overall delay due to the initial decoding load of respective programs on the channels when using the favorite channel list.

As mentioned, the favorite channel list implemented according to the related art does not serve the user well. Thus, a novel method and associated multi-channel broadcasting program receiver are required for solving the related art problems.

### SUMMARY

It is therefore an objective of the claimed invention to provide a method for providing a user with a program finding service in a multi-channel broadcasting program receiver, and to provide an associated multi-channel broadcasting program receiver to solve the above-mentioned problems.

An exemplary embodiment of a method for providing a user with a program finding service in a multi-channel broadcasting program receiver comprises: storing a list comprising a plurality of items, wherein each item represents a program; providing the user with a user interface to allow the user to add, change or adjust an item in the list; and outputting at least a portion of items of the list to be displayed on a screen and allowing the user to select a wanted program from the list, in order to trigger a switching operation for switching to a new channel on which the wanted program is transmitted.

An exemplary embodiment of a multi-channel broadcasting program receiver comprises a tuner, a video processing module, a memory and a controller. The tuner is arranged to select one of a plurality of channels, and the video processing module is arranged to decode according to selection of the tuner. In addition, the memory is arranged to store a list comprising a plurality of items, wherein each item represents a program. Additionally, the controller is arranged to provide a user with a program finding service, wherein the controller provides the user with a user interface to allow the user to add, change or adjust an item in the list. When the user triggers a finding operation intended for finding a wanted program, the controller controls the video processing module to output at least a portion of items of the list to be displayed on a screen and allows the user to select the wanted program from the list, in order to trigger a switching operation for switching to a new channel on which the wanted program is transmitted.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a multi-channel broadcasting program receiver according to a first embodiment of the present invention.

FIG. 2 is a flowchart of a method for providing a user with a program finding service in a multi-channel broadcasting program receiver according to one embodiment of the present invention.

FIG. 3 illustrates a favorite program list utilized by the method shown in FIG. 2.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

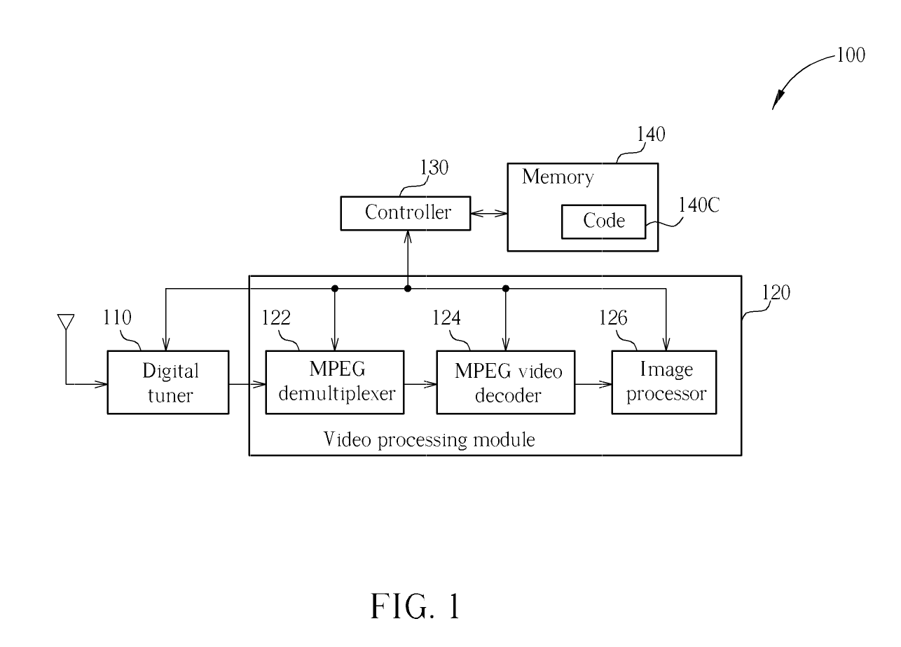

Please refer to FIG. 1. FIG. 1 is a diagram of a multi-channel broadcasting program receiver 100 according to a first embodiment of the present invention. The multi-channel broadcasting program receiver 100 comprises a tuner such as a digital tuner 110, a video processing module 120, a controller 130 and a memory 140. The digital tuner 110 is arranged to select one of a plurality of channels, and the video processing module 120 is arranged to decode according to selection of the digital tuner 110. In addition, the controller 130 is arranged to provide a user with a program finding service. In this embodiment, the controller 130 is a micro control unit (MCU) executing a code 140C stored in the memory 140. According to a variation of this embodiment, the controller 130 can be a hardware controller with the code 140C embedded therein. That is, whether a program code such as the code 140C is stored in a memory such as the memory 140 depends on different variations of this embodiment.

According to the first embodiment, the video processing module 120 comprises an MPEG demultiplexer 122, an MPEG video decoder 124 and an image processor 126. The MPEG demultiplexer 122 is arranged to demultiplex video content and audio content of a program on the channel selected by the digital tuner 110. In addition, the MPEG video decoder 124 is arranged to decode the video content demultiplexed by the MPEG demultiplexer 122, and more particularly, to perform MPEG-decoding on the video content. Additionally, the image processor 126 may further perform image processing on the decoded video content to be displayed. Please note that whether an on screen display (OSD) processing circuit is utilized for processing the video content to be displayed depends on different variations of this embodiment. In addition, according to different variations of this embodiment, a display module can be integrated into the multi-channel broadcasting program receiver 100.

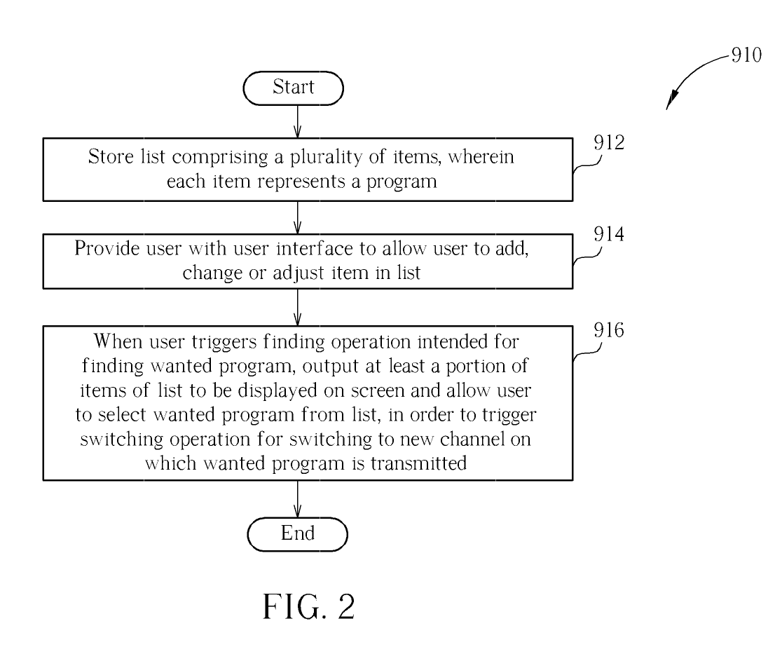

FIG. 2 is a flowchart of a method 910 for providing a user with a program finding service in a multi-channel broadcasting program receiver according to one embodiment of the present invention. The method 910 can be applied to the multi-channel broadcasting program receiver 100 shown in FIG. 1, and can be implemented by utilizing the multi-channel broadcasting program receiver 100. Thus, the method 910 is described according to the first embodiment as follows.

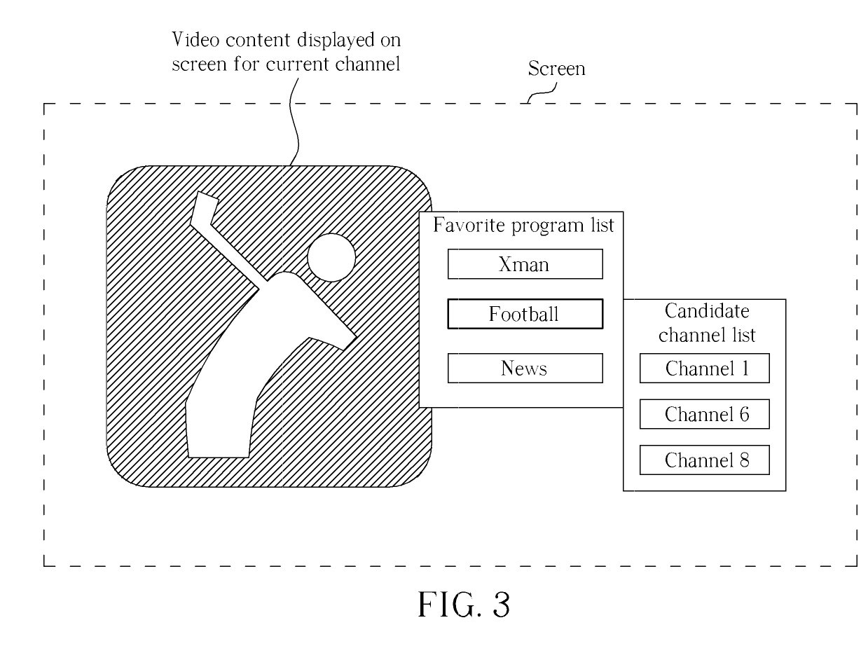

In Step 912, the controller 130 executing the code 140C utilizes a memory such as the memory 140 to store a list comprising a plurality of items, wherein each item represents a program. More particularly, the list of this embodiment can be referred to as a favorite program list such as that shown in FIG. 3.

In Step 914, the controller 130 executing the code 140C provides the user with a user interface to allow the user to add, change or adjust an item in the list. From an electronic program guide (EPG), the controller 130 of this embodiment can derive a program name of a program on a current channel that the user is viewing. When needed (e.g. when confirmed by the user), the controller 130 adds the program name into the list. The user may keep the program name that the controller initially sets, or change the program name to a simplified name. For example, a series of episodes of a program Xman are broadcast with numbered program names Xman-1, Xman-2, . . . , and Xman-N, and the user may change or adjust their names to be Xman for brevity in the list.

As mentioned, the controller 130 of this embodiment can derive a program name of a program on the current channel from the EPG. This is only for illustrative purposes, and is not meant to be a limitation of the present invention. According to a variation of the first embodiment, from a data stream of a program on the current channel that the user is viewing, the controller 130 executing a varied version of the code 140C derives a program name of the program on the current channel.

In Step 916, when the user triggers a finding operation intended for finding a wanted program, the controller 130 executing the code 140C controls the video processing module 120 to output at least a portion of items of the list to be displayed on a screen and allows the user to select a wanted program from the list, in order to trigger a switching operation for switching to a new channel on which the wanted program is transmitted.

According to this embodiment, the controller 130 executing the code 140C performs statistical operations on programs viewed by the user with respect to time in order to generate statistical results representing the user's preferred program(s) of time period(s) of a day and/or the user's preferred program(s) of time period(s) of a week in advance, and often updates the statistical results. As a result, the controller 130 executing the code 140C may control the video processing module 120 to output items corresponding to the current time according to the statistical results.

More particularly, the controller 130 of this embodiment controls the multi-channel broadcasting program receiver 100 to search a plurality of channels to determine whether one or more candidate channels of the plurality of channels match at least one item in the list. When determining one or more candidate channels of the plurality of channels match at least one item in the list, the controller 130 allows the user to select a candidate channel from the candidate channels that match the item(s) with a candidate channel list being displayed for selection purposes, such as the candidate channel list illustrated in FIG. 3.

According to the first embodiment, the controller 130 executing the code 140C compares the items in the list with program names of programs on the channels in the EPG, respectively. This is only for illustrative purposes, and is not meant to be a limitation of the present invention. According to a variation of the first embodiment, the controller 130 executing a varied version of the code 140C compares the items in the list with program names carried by data streams of programs on the channels, respectively.

In addition, when performing the comparison mentioned above, different criteria can be applied when needed. The controller 130 executing the code 140C may inquire the user for which matching criterion should be applied, or determines to utilize a default matching criterion. For example, the controller 130 compares the items in the list with program names of programs on the channels by utilizing a strict matching criterion. In another example, the controller 130 compares the items in the list with program names of programs on the channels by utilizing a loose matching criterion.

According to this embodiment, when the wanted program is a program to be transmitted on the new channel, the controller 130 executing the code 140C allows the user to determine whether to switch to the new channel at once or automatically switches to the new channel around a start time of the wanted program. In addition, the controller 130 executing the code 140C may determine whether a specific item in the list is expired according to a threshold value (e.g. a threshold value representing three months). When determining the specific item in the list is expired, the controller 130 executing the code 140C deletes the specific item.

In contrast to the related art, the present invention method and the associated multi-channel broadcasting program receiver provides better viewing experiences by providing the aforementioned list such as the favorite program list shown in FIG. 3.

It is another advantage of the claimed invention that the present invention method and the associated multi-channel broadcasting program receiver can significantly save the user's time.

It is another advantage of the claimed invention that the present invention method and the associated multi-channel broadcasting program receiver can greatly decrease the probability of the aforementioned unnecessary channel switching that typically occurs in the related art.

Those skilled in the art will readily observe that numerous modifications and alterations of the device and method may be made while retaining the teachings of the invention.

What is claimed is:

1. A method for providing a user with a program finding service in a multi-channel broadcasting program receiver, the method comprising:
storing a list comprising a plurality of items, wherein each item represents a program;
providing the user with a user interface to allow the user to add, change or adjust an item in the list; and
outputting at least a portion of items of the list to be displayed on a screen and allowing the user to select a wanted program from the list, in order to trigger a switching operation for switching to a new channel on which the wanted program is transmitted.

2. The method of claim 1, further comprising:
performing statistical operations on programs viewed by the user with respect to time in order to generate statistical results;
wherein the step of outputting the portion of the items of the list to be displayed on the screen further comprises:
outputting items corresponding to a current time according to the statistical results.

3. The method of claim 1, further comprising:
from an electronic program guide (EPG) or from a data stream of a program on a current channel that the user is viewing, deriving a program name of the program on the current channel; and
adding the program name into the list.

4. The method of claim 1, further comprising:
searching a plurality of channels to determine whether one or more candidate channels of the plurality of channels match at least one item in the list; and
when determining one or more candidate channels of the plurality of channels match at least one item in the list, allowing the user to select a candidate channel from the candidate channels that match the item(s).

5. The method of claim 4, wherein the step of searching the plurality of channels to determine whether one or more channels of the plurality of channels match the wanted program represented by the corresponding item in the list further comprises:
comparing the items in the list with program names of programs on the channels in an electronic program guide (EPG), respectively.

6. The method of claim 4, wherein the step of searching the plurality of channels to determine whether one or more channels of the plurality of channels match the wanted program represented by the corresponding item in the list further comprises:
comparing the items in the list with program names carried by data streams of programs on the channels, respectively.

7. The method of claim 4, wherein the step of searching the plurality of channels to determine whether one or more channels of the plurality of channels match the wanted program represented by the corresponding item in the list further comprises:
comparing the items in the list with program names of programs on the channels by utilizing a strict matching criterion.

8. The method of claim 4, wherein the step of searching the plurality of channels to determine whether one or more channels of the plurality of channels match the wanted program represented by the corresponding item in the list further comprises:
comparing the items in the list with program names of programs on the channels by utilizing a loose matching criterion.

9. The method of claim 1, further comprising:
when the wanted program is a program to be transmitted on the new channel, allowing the user to determine whether to switch to the new channel at once, or automatically switching to the new channel around a start time of the wanted program.

10. The method of claim 1, further comprising:
determining whether a specific item in the list is expired; and
when determining the specific item in the list is expired, deleting the specific item.

11. A multi-channel broadcasting program receiver comprising:
a tuner arranged to select one of a plurality of channels;
a video processing module arranged to decode according to selection of the tuner;
a memory arranged to store a list comprising a plurality of items, wherein each item represents a program; and
a controller arranged to provide a user with a program finding service, wherein the controller provides the user with a user interface to allow the user to add, change or adjust an item in the list;
wherein when the user triggers a finding operation intended for finding a wanted program, the controller controls the video processing module to output at least a portion of items of the list to be displayed on a screen and allows the user to select the wanted program from the list, in order to trigger a switching operation for switching to a new channel on which the wanted program is transmitted.

12. The multi-channel broadcasting program receiver of claim 11, wherein the controller performs statistical operations on programs viewed by the user with respect to time in order to generate statistical results; and when controlling the video processing module to output the portion of the items of the list to be displayed on the screen, the controller controls the video processing module to output items corresponding to a current time according to the statistical results.

13. The multi-channel broadcasting program receiver of claim 11, wherein the controller derives a program name of a program on a current channel that the user is viewing from an electronic program guide (EPG) or from a data stream of the program on the current channel that the user is viewing; and the controller adds the program name into the list.

14. The multi-channel broadcasting program receiver of claim 11, wherein the controller controls the multi-channel broadcasting program receiver to search a plurality of channels to determine whether one or more candidate channels of the plurality of channels match at least one item in the list; and when determining one or more candidate channels of the plurality of channels match at least one item in the list, the controller allows the user to select a candidate channel from the candidate channels that match the item(s).

15. The multi-channel broadcasting program receiver of claim 14, wherein the controller compares the items in the list with program names of programs on the channels in an electronic program guide (EPG), respectively.

16. The multi-channel broadcasting program receiver of claim 14, wherein the controller compares the items in the list with program names carried by data streams of programs on the channels, respectively.

17. The multi-channel broadcasting program receiver of claim 14, wherein the controller compares the items in the list with program names of programs on the channels by utilizing a strict matching criterion.

18. The multi-channel broadcasting program receiver of claim 14, wherein the controller compares the items in the list with program names of programs on the channels by utilizing a loose matching criterion.

19. The multi-channel broadcasting program receiver of claim 11, wherein when the wanted program is a program to be transmitted on the new channel, the controller allows the user to determine whether to switch to the new channel at once or automatically switches to the new channel around a start time of the wanted program.

20. The multi-channel broadcasting program receiver of claim 11, wherein the controller determines whether a specific item in the list is expired; and when determining the specific item in the list is expired, the controller deletes the specific item.
